(19) United States
(12) Patent Application Publication
(10) Pub. No.: US 2024/0170759 A1
(43) Pub. Date: May 23, 2024

(54) A SYSTEM AND A METHOD FOR THERMAL MANAGEMENT OF BATTERY CELLS IN A BATTERY SYSTEM

(71) Applicant: Nerve Smart Systems A/S, Roskilde (DK)

(72) Inventor: Gunnar ROHDE, Rødovre (DK)

(21) Appl. No.: 18/552,018

(22) PCT Filed: Mar. 24, 2022
(86) PCT No.: PCT/DK2022/050059

§ 371 Date: Sep. 22, 2023

(30) Foreign Application Priority Data
Mar. 25, 2021 (DK) PA 2021 70136

(51) Int. Cl. H01M 10/6553; H01M 10/613; H01M 10/627; H01M 10/653; H01M 10/6551; H01M 10/6552; H01M 50/552; H01M 50/562

(52) U.S. Cl. CPC H01M 10/6553; H01M 10/613; H01M 10/627; H01M 10/653; H01M 10/6551; H01M 10/6552; H01M 50/552; H01M 50/562; H01M 2220/10

(57) ABSTRACT

A system (1) for thermal management of battery cells in a battery system (2), such as a battery system for a charging station for electrical vehicles, the system (1) comprising a battery system (2) comprising a plurality of battery cell assemblies (3), each battery cell assembly (3) comprising a plurality of battery cells, and electrical circuitry (4) connecting the individual battery cell assemblies (3) of the plurality of battery cell assemblies (3). At least one battery cell assembly (3) of the plurality of battery cell assemblies (3) is provided with an extension element (7) configured to provide heat conduction from the battery cell assembly (3) to the exterior (12), and the at least one extension element (7) is arranged between a terminal (6) of the battery cell assembly (3) and the electrical circuitry (4) connected to the terminal (6) of the battery cell assembly (3).

### TECHNICAL FIELD

The present invention relates to a system and a method for thermal management of battery cells in a battery system, the system comprising a battery system comprising a plurality of battery cell assemblies, each battery cell assembly comprising a plurality of battery cells, and electrical circuitry connecting the individual battery cell assemblies of the plurality of battery cell assemblies.

### BACKGROUND ART

Due to their comparatively high energy density, lithium-based battery cells, battery packs, battery modules, and battery systems need continuous monitoring and supervision of their operating ranges and parameters as they are illustrated in FIGS. 1 and 2. The overall challenge for an effective, efficient, and safe operation of batteries is to maximise the safe operating zone shown in FIGS. 1 and 2, while minimising both the safety margin and the failure zone shown in FIGS. 1 and 2. This requires an accurate and precise monitoring, supervision, and control of the operating temperature of individual battery cells, battery packs, and battery modules within in a battery system. This comprises supervision and control of both the environmental temperature heating and/or cooling of a battery system as well as the internal heat generated inside the individual battery cells during operation.

Whereas thermal management of the environmental temperature of battery systems is sufficiently handled by commercially available thermal management systems, the supervision and control of thermal energy generated inside a single individual battery cell is much more challenging. In theory, lithium-based battery cells are optimally cooled/heated via its anode and/or cathode electrode. These metal-based current collectors provide large surface areas, high thermal conductivity, and are in direct contact with the electrode-electrolyte-interfaces where most of the battery cell's internal heat is generated.

In practical applications, however, one does typically not deal with single battery cells because of their limited maximum current density at the electrodes that cannot provide the demanded power in most situations. Instead, certain cell assemblies are deployed as practical building blocks of battery packs, battery modules, and battery systems with a sufficient total current/power density.

The main challenge for thermal management of battery packs, battery modules, and battery systems is therefore the accurate and precise supervision and control the temperature of individual battery cells when these are deployed in form of battery cell assemblies where the electrical connection of individual battery cells (or, at least, their physical layup) is typically in parallel. In particular, with increasing size of a battery cell assembly, and thus increasing maximum current density, the thermal gradients due to heat generated internally cannot be neglected.

A variety of technical solutions for thermal management within battery packs, battery modules, and battery systems exist that also aim to take care for supervision and control of heat generated inside the individual battery cells. Four exemplary and widely used thermal management methodologies for battery cell assemblies are known as direct air-cooling, indirect air-cooling, indirect liquid-cooling, and direct liquid-cooling, respectively. These thermal management methodologies are used for a variety of types of battery cell assemblies.

Mainly, the different thermal management methodologies are adapted on different system levels to the various modular and scalable battery modules, battery packs, and battery systems built out of the different battery cell assemblies. The combination of different thermal management methodologies on different systems levels is common.

The major disadvantage with the current state of thermal management methodologies for battery cell assemblies is that they do not take into account the parallel electrical connection and/or physical layup of the individual battery cells inside an assembly. Actually, with most of the current thermal management methodologies mentioned above, the individual battery cells inside a battery assembly are cooled and/or heated in series. Therefore, the outermost battery cell gets the most cooling and/or heating power while the innermost battery cell gets the lowest cooling and/or heating power. Furthermore, applying more cooling and/heating power to the innermost battery cell of an assembly will automatically apply additional cooling and/or heating power to all the other battery cell as well—even if they do not need this additional cooling and/or heating.

In fact, the innermost battery cell typically demands the highest cooling power inside a battery assembly. Hence, when cooling the innermost battery cell sufficiently, all the other battery cells in that assembly are cooled too much. The other way round, when the outermost battery cell in an assembly is optimally cooled, all other battery cells are normally not cooled sufficiently.

A result of insufficient and/or suboptimal thermal management of battery cells, battery packs, battery modules, or battery systems is primarily that the operator/user of a battery system will experience a low quality with respect to performance, lifetime, and total cost of ownership (TCO).

### SUMMARY OF INVENTION

It is therefore the object of the invention to provide a system for thermal management of battery cells in a battery system with which at least some of the above advantages may be minimized or avoided altogether.

It is a further object of the invention to provide such a system which provides for accurate and precise supervision and control of the temperature of individual battery cells in a battery pack.

It is a still further object of the invention to provide such a system which provides for modular and scalable thermal management of battery packs, modules, and systems that are based on battery assembly cooling and heating solutions, and which takes into account the electrical connection and the physical layup of the individual battery cells inside an assembly.

The invention is defined by the subject matter of the independent claims. Particular embodiments of the invention are set out in the dependent claims.

These and other objects are achieved by means of a system for thermal management of battery cells in a battery system, the system comprising a battery system comprising a plurality of battery cell assemblies, each battery cell assembly comprising a plurality of battery cells, and electrical circuitry connecting the individual battery cell assemblies of the plurality of battery cell assemblies, where at least one battery cell assembly of the plurality of battery cell assemblies is provided with at least one extension element configured to provide heat conduction from the battery cell assembly to the exterior, where the at least one extension element is arranged between a terminal of the battery cell assembly and the electrical circuitry connected to the terminal of the battery cell assembly.

Thereby, and in particular by providing at least one battery cell assembly of the plurality of battery cell assemblies with at least one extension element configured to provide heat conduction from the battery cell assembly to the exterior and being arranged between a terminal of the battery cell assembly and the electrical circuitry connected to the terminal of the battery cell assembly, a system which provides for accurate and precise supervision and control of the temperature of individual battery cells in a battery pack is obtained.

By particularly arranging the extension element between a terminal of the battery cell assembly and the electrical circuitry connected to the terminal of the battery cell assembly, a system which provides for modular and scalable thermal management of battery packs, battery modules, and battery systems that are based on battery assembly cooling and heating solutions is further obtained. Such a system also enables taking into account the electrical connection and the physical layup of the individual battery cells inside an assembly.

Thus, the mentioned advantages are not only obtained for the battery cell assembly comprising an extension element, but even for each individual battery cell of such a battery cell assembly.

In an embodiment, each battery cell assembly of the plurality of battery cells assemblies is provided with at least one extension element configured to provide heat conduction from the battery cell assembly to the exterior, where the at least one extension element is arranged between a terminal of the battery cell assembly and the electrical circuitry connected to the terminal of the battery cell assembly.

Thereby, a system is provided with which each and all battery cell assemblies are cooled and with which the above-mentioned advantages are thus obtained for all battery cell assemblies, and consequently also all individual battery cells, of the battery pack.

In an embodiment, the extension element comprises a core member and at least one cooling fin.

Such fins provide an additional cooling effect in addition to the thermal conductivity of the extension element itself. Thus, an extension element is thereby provided with which an improved and particularly efficient cooling may be obtained.

In an embodiment, the at least one cooling fin extends outwards, such as radially outwards, from the core member, i.e. away from a center axis of the core member, such as to enhance the effect leading heat away from the core member and thus from the battery assembly.

In an embodiment, the at least one cooling fin comprise an outer periphery, and the outer periphery comprises a shape being any one of circular, angular, rectangular, hexagonal, octangular and combinations of two or more thereof.

An angular, such as rectangular, hexagonal or octangular, periphery of the fin provides the advantage of making the extension element particularly simple to mount since the periphery may the act as an engagement surface for engagement with a suitable tool, such as a wrench or a spanner or an adjustable wrench or spanner.

In an embodiment, the at least one cooling fin comprise an outer periphery a diameter being at least 3 mm larger than an outer diameter of the core member of the extension element.

Thereby, an extension element is provided with which the fins contribute particularly well to the cooling effect.

In an embodiment, the extension element is made of a material having a high thermal conductivity.

Thereby, an extension element is provided with which a highly efficient cooling may be obtained.

In an embodiment, the extension element is made of a material further having a high electrical conductivity.

Thereby, an extension element is provided which interferes minimally with the electrical connection between the terminal of the battery cell assembly and the electrical circuitry.

In an embodiment, the extension element is made of a metal such as brass or aluminium. Such materials are examples of materials having particularly advantageous properties in terms of thermal and electric conductivity, while also being relatively cheap.

In an embodiment, the extension element comprises at least one of a height of between 5 mm and 15 mm and an outer diameter of between 10 mm and 30 mm.

Such dimensions as been shown to provide a suitable trade off between the desire to provide sufficient cooling and the desire to keep the system, and especially the extension element, small.

In an embodiment, the extension element comprises a through hole with an inner surface being plain or threaded.

Thereby a particularly simple construction is provided for. Furthermore, such an element is particularly simple to mount between the terminal and the electrical circuitry as it may be mounted using the same fastening element, such as a screw or a bolt, as is used to attach the electrical circuitry and battery management system to the terminals of the battery cell assemblies.

In a second aspect of the invention, the above and other objects are solved by means of an extension element configured for thermal management of battery cells in a battery system, such as a battery system for a charging station for electrical vehicles, the battery system comprising a battery pack comprising a plurality of battery cell assemblies, each battery cell assembly comprising a plurality of battery cells, and electrical circuitry connecting the individual battery cell assemblies of the plurality of battery cell assemblies, where the extension element is configured to provide heat conduction from the battery cell assembly to the exterior, and where the extension element is configured to be arranged between a terminal of the battery cell assembly and the electrical circuitry connected to the terminal of the battery cell assembly.

The extension element may in some embodiments further comprise one or more of a core member and one or more cooling fins, a material having a high thermal conductivity, a material having a high electrical conductivity, a material being brass or aluminium, a through hole with an inner surface being plain or threaded, a height of at least 5 mm, and an outer diameter of at least 10 mm.

In some embodiments, the extension element comprises a core member and one or more cooling fins. In such embodiments, the one or more fins comprise an outer periphery, and the outer periphery may comprise any one or more of a shape being any one of circular, angular, rectangular, hexagonal, octangular and combinations of two or more thereof. The outer periphery may further comprise a diameter being at least 3 mm larger than an outer diameter of the core member of the extension element.

### BRIEF DESCRIPTION OF DRAWINGS

In the following description embodiments of the invention will be described with reference to the schematic drawings, in which

FIGS. 1 and 2 shows two diagrams illustrating a qualitative description of safe operating ranges, safety margins, and failure zones of lithium-based secondary batteries with respect to their operating parameters. FIG. 1 shows the magnitude of current of the battery cell as a function of temperature. FIG. 2 shows the voltage of the battery cell as a function of temperature.

FIG. 3 shows a perspective view of a system according to the invention comprising a plurality of battery cells assemblies, each comprising an extension element.

FIG. 4 shows a schematic illustration of the impact of an extension element according to the invention on the temperature of a battery cell.

FIG. 5 shows a schematic illustration of the temperature of a battery cell of a prior art system.

FIG. 6 shows a perspective view of an extension element according to the invention.

FIG. 7 shows a perspective view of an extension element according to the invention and comprising fins.

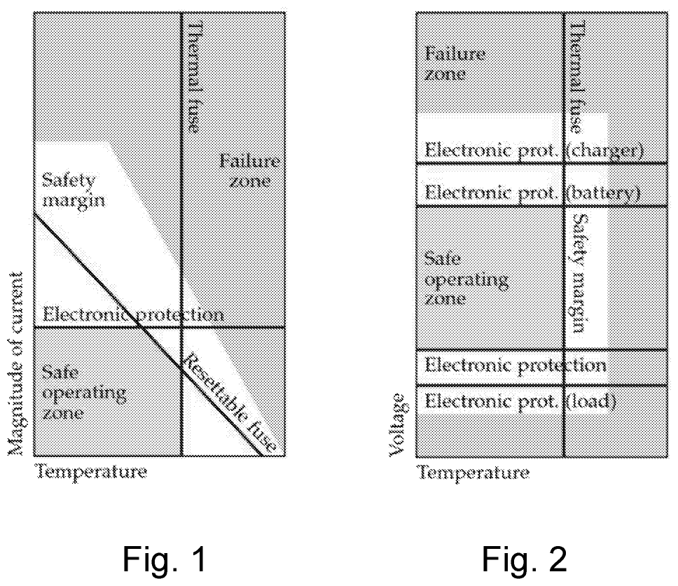

### DESCRIPTION OF EMBODIMENTS

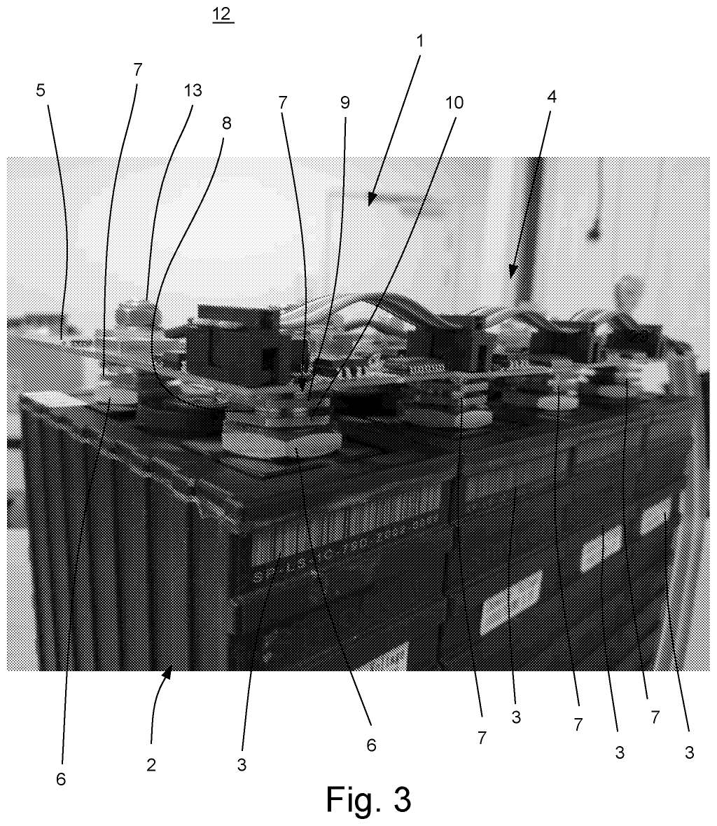

FIG. 3 shows a perspective view of a system 1 according to the invention. The system 1 is a system 1 for thermal management of battery cell assemblies 3 and individual battery cells in a battery system 2. A system according to the invention may be employed for thermal management of battery cell assemblies 3 and individual battery cells in a battery system 2 for any feasible application, examples including charging systems for electrically powered vehicles, wind energy systems, solar energy systems, hydro energy systems and many more applications in which battery systems are needed or used.

The battery system 2 comprises a plurality of battery cell assemblies 3. The battery system 2 may be any feasible type of battery system to be used in applications where battery power of a magnitude requiring a plurality of battery cell assemblies 3 is needed. For instance, the battery system 2 may be used in a charging station for charging electrical vehicles. The battery system 2 may also be used as the battery system installed in the electrical vehicle itself. The battery system 2 may comprise any feasible number of battery cell assemblies 3. The battery cell assemblies 3 may thus also be any feasible type of battery cell assemblies 3 depending on the application in which the battery system 2 is to be used. One non-limiting example of a suitable battery cell assembly is a 100 Ah lithium-iron phosphate battery cell assembly. Each battery cell assembly comprises a plurality of battery cells (not visible on FIG. 3). The battery cells may thus also be any feasible type of battery cells depending on the application in which the battery system 2 is to be used. Each battery cell assembly 3 may comprise any feasible number of battery cells.

The battery system 2 further comprises electrical circuitry 4 configured to connect the battery cell assemblies 3 of the battery system 2. The electrical circuitry 4 is in the embodiment shown in FIG. 2 configured to connect the battery cell assemblies 3 of the battery system 2 in a parallel configuration. The individual battery cells of each battery cell assembly 3 are likewise connected in a parallel configuration. The electrical circuitry 4 may be arranged on a printed circuit board 5 or like substrate. The electrical circuitry 4 is connected to the terminals 6 of each battery cell assembly 3. The electrical circuitry 4 may furthermore provide a connection to external elements, such as components of an application to be powered by the battery system 2. The electrical circuitry 4 may furthermore comprise a battery management system, such as the applicant's Nerve Switch® battery management system described in the applicant's WO 2018/072799 A1 or in principle any other suitable battery management system.

Generally, all the individual battery cells of each battery cell assembly 3 in the battery system 2 are connected in parallel, the two battery terminals 6 of each battery cell assembly 3 are connected in parallel, the plurality of battery cells of each battery cell assembly 3 is connected in parallel, and the electrical circuitry 4 is connected in parallel with the battery system 2. In principle, the system 1 according to the invention may comprise more than one such battery system 2, in which case the battery systems 2 are also connected in parallel.

The battery system 2 further comprises at least one extension element 7. In the embodiment shown on FIG. 3, each battery cell assembly 3 of the plurality of battery cell assemblies 3 is provided with an extension element 7. In other embodiments only some of the battery cell assemblies 3 of the battery system 2 may be provided with an extension element 7. In yet other embodiments one or more battery cell assemblies 3 may be provided with more than one, e.g. two, extension elements 7.

The extension element 7 is generally configured to provide heat conduction from the battery cell assembly 3 and the individual battery cells therein to the exterior 12. Therefore, the extension element 7 is made of a material having a high thermal conductivity. Such materials include suitable metals such as aluminium or brass. The extension element 7 is arranged between a terminal 6 of the battery cell assembly 3 and the part of the electrical circuitry 4 that is connected to the terminal 6 of the battery cell assembly 3. To enable a suitably strong electrical connection between the electrical circuitry 4 and the terminal 6 of the battery cell assembly 3, the extension element 7 may further be made of a material having a high electrical conductivity.

The extension elements 7 provide a controlled airflow through the area between the upper surface of the battery cell assembly 3 and the lower surface of the printed circuit board 5. This generates a (turbulent) airflow around the extension elements 7 and hence provides cooling. In particular cooling is provided of all the individual battery cells inside a battery assembly 3 in parallel, of the two battery terminals 6 of the battery assembly 3 in parallel, of all battery cells 3 inside a battery assembly 3 in parallel, and of the electrical circuitry 4 with or without battery management system in parallel with the battery cell assemblies 3.

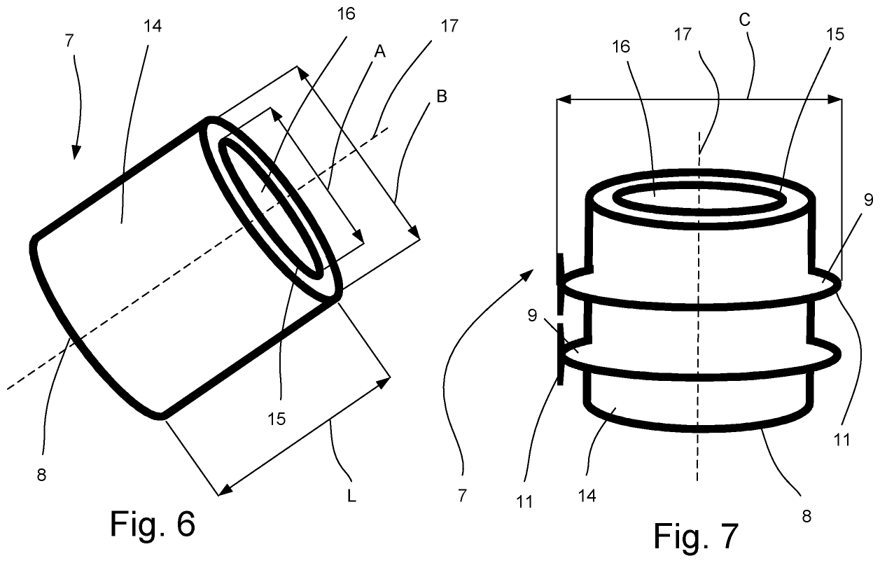

Referring now also to FIGS. 6 and 7, the extension element 7 comprises a core member 8. The core member 8 is generally cylindrical with a longitudinal center axis 17, an outer surface 14, an inner surface 15 and a through hole 16. In the embodiment shown, the core member 8 is circular in cross section, although it may in principle also have any other feasible cross-sectional shape. The through opening 16 allows passage of a fastening member 13, such as a screw or bolt, for attaching the extension element 7 and the electrical circuit 4 to the terminal 6 of the battery cell. The inner surface 15 may be a plain or a threaded surface. The core element 8 further comprises an outer diameter A and an inner diameter B. The outer diameter A and the inner diameter B may be chosen such that the thickness T of the core member 8 defined as T=A−B is between 1 mm and 3 mm or between 1 mm and 5 mm. The outer diameter A may be chosen to be more than 5 mm, more than 10 mm or more than 12 mm. The inner diameter B may be chosen to be between 2 mm and 4 mm, between 2 and 6 mm or between 2 and 9 mm. The extension element 7 further comprises a length L. The length L may be chosen to be between 5 mm and 30 mm.

The extension element 7 according to FIG. 6 does not comprise any fins. The extension element 7, however, may further comprise one or more fins 9. As shown in FIG. 7, the extension element 7 comprises two fins 9. Any other number of fins 9, such as one, three or five fins 9 may also be provided. The fins 9 are cooling fins and provide an improved cooling effect. The fins 9 extend outwards, such as radially outwards, from the core member 8, i.e. away from the longitudinal center axis 17 of the core member 8. The fins 9 may be made of the same material as the core member 8 or it may be made of a different, yet still heat conductive, material. The fins 9 comprise an outer diameter C. The outer diameter C may be chosen to be at least 5 mm larger than the outer diameter A of the core member 8. As shown on FIG. 7 the fins 9 have a periphery 11 being generally circular in shape. However, other shapes of the periphery 11 of the fins 9, such as angular, e.g. rectangular, pentangular or hexagonal, are also feasible. For instance, the fins 9 of the extension elements 7 shown on FIG. 3 are provided with a hexagonal periphery 11.

### Example

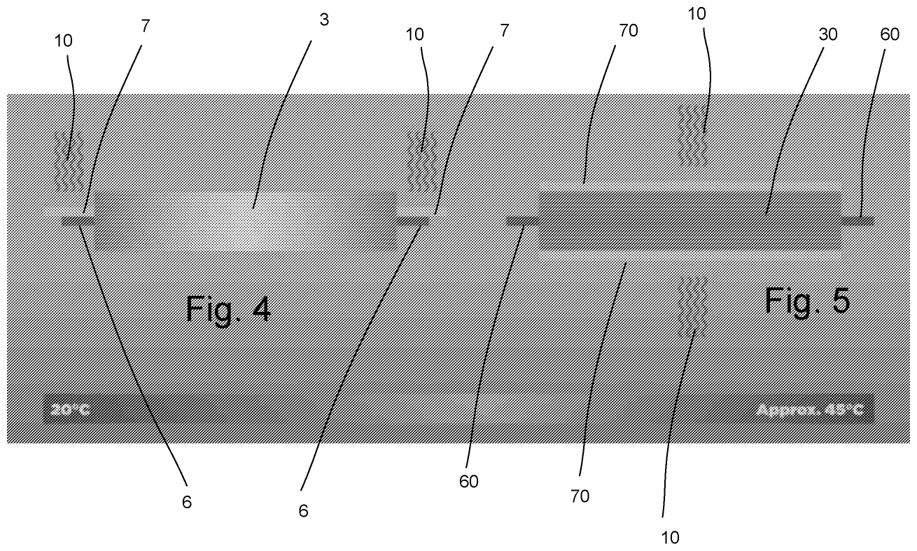

Reference is now made to FIGS. 4 and 5. FIG. 4 shows a schematic illustration of the impact of an extension element 7 according to the invention on the temperature of an individual battery cell or a battery assembly 3. FIG. 5 shows a schematic illustration of the temperature of a battery cell assembly 30 of a prior art system. On these figures the grey tones applied to the battery cell assembly 3, respectively 30, illustrate the temperature of the battery cell as indicated in the scale shown.

As may be seen from FIG. 5, prior art battery cell assemblies 30 cooled by using surface cooling elements 70 arranged separately from the terminals 60 of the battery cells and cooling the battery cells serially do cool the surface of the battery cell assembly 30 near the cooling element 70 to about 20° C. or room temperature. However, the core of the battery cell assembly 30 is insufficiently cooled and comprises a temperature of about 45° C. The same considerations apply to each of the individual battery cells of the battery cell assembly 30, where a battery cell assembly near the outer surface of the battery cell assembly 30 would be sufficiently cooled, while a battery cell nearer to the center of the battery cell assembly 30 would be cooled insufficiently.

In comparison, referring to FIG. 4, a battery cell assembly 3 cooled by using a system 1 according to the invention employing extension elements 7 according to the invention arranged at the terminals 6 of the battery cell assembly 3, and thus cooling the battery cell assembly 3 in parallel, cool the entire battery cell assembly 3 to temperatures not exceeding 30-32° C. In other words, using a system 1 according to the invention and extension elements 7 according to the invention improves the overall cooling of the battery cell assembly 3, and, in particular, the cooling of the central part of the battery cell 3 considerably. The same considerations apply to each of the individual battery cells of the battery cell assembly 3, where all battery cells including the battery cells nearer to the center of the battery cell assembly 3 would now be sufficiently cooled.

As is clear from FIGS. 4 and 5, a system 1 according to the invention thus shows a cooling performance being considerably better than the prior art systems. Especially, since all of the components and subsystems inside the system 1 are typically loaded with the same electrical current, and hence generate a comparable amount of heat, the applied thermal management methodology according to the present invention shows superior performance.

Furthermore, by applying a controlled airflow of elevated temperature to a system 1 according to the invention, it is rather than cooling also possible to heat all involved components and subsystems to optimal temperatures. This may be of advantages for battery systems used in cold environments, such as in the winter, in polar areas or elsewhere where low, particularly sub-zero degree Celsius, temperatures prevail.

In combination with a suitable battery management system, such as the applicant's Nerve Switch® battery management system for reconfigurable battery systems with variable topology, the performance of the thermal management system 1 according to the invention is improved further when the predictive battery cell topology also takes the (internal) battery cell temperature into account.

The person skilled in the art realizes that the present invention by no means is limited to the preferred embodiments described above. On the contrary, many modifications and variations are possible within the scope of the appended claims.

### LIST OF REFERENCE NUMERALS

1 System
2 Battery system
3 Battery cell assembly
4 Electrical circuitry
5 Printed Circuit Board
6 Terminal
7 Extension element
8 Core member
9 Fins
10 Heat
11 Outer periphery
12 Exterior
13 Fastening element
14 Outer surface
15 Inner surface
16 Through hole
17 Longitudinal axis
A Outer diameter
B Inner diameter
C Diameter of fin
L Length

1. A system for thermal management of battery cells in a battery system, such as a battery system for a charging station for electrical vehicles, the system comprising:
a battery system comprising a plurality of battery cell assemblies, each battery cell assembly comprising a plurality of battery cells, and electrical circuitry connecting the individual battery cell assemblies of the plurality of battery cell assemblies, wherein
at least one battery cell assembly of the plurality of battery cell assemblies is provided with at least one extension element configured to provide heat conduction from the battery cell assembly to the exterior, wherein
the at least one extension element is arranged between a terminal of the battery cell assembly and the electrical circuitry connected to the terminal of the battery cell assembly.

2. A system according to claim 1, wherein each battery cell assembly of the plurality of battery cell assemblies is provided with at least one extension element configured to provide heat conduction from the battery cell assembly to the exterior, wherein
the at least one extension element is arranged between a terminal of the battery cell assembly and the electrical circuitry connected to the terminal of the battery cell assembly.

3. A system according to claim 1, wherein the extension element comprises at least one of a core member and one or more cooling fins.

4. A system according to claim 3, wherein the one or more cooling fins comprise an outer periphery, and wherein the outer periphery comprises a shape being any one of circular, angular, rectangular, hexagonal, octangular and combinations of two or more thereof.

5. A system according to claim 3, wherein the one or more cooling fins comprise an outer periphery with a diameter (C) being at least 3 mm larger than an outer diameter (A) of the core member of the extension element.

6. A system according to claim 1, wherein the extension element is made of any one or more of:
a material having a high thermal conductivity,
a material having a high electrical conductivity, and
brass or aluminium.

7. A system according to claim 1, wherein the extension element comprises any one or more of:
at least one of a length (L) of between 5 mm and 15 mm and an outer diameter (A) of between 10 mm and 30 mm, and
a through hole with an inner surface being plain or threaded.

8. An extension element configured for thermal management of battery cells in a battery system, such as a battery system for a charging station for electrical vehicles, the battery system comprising a plurality of battery cell assemblies, each battery cell assembly comprising a plurality of battery cells, and electrical circuitry connecting the individual battery cell assemblies of the plurality of battery cell assemblies, wherein
the extension element is configured to provide heat conduction from the battery cell assembly to the exterior, and wherein
the extension element is configured to be arranged between a terminal of the battery cell assembly and the electrical circuitry connected to the terminal of the battery cell assembly.

9. An extension element according to claim 8, and further comprising one or more of:
a core member and one or more cooling fins,
a material having a high thermal conductivity,
a material having a high electrical conductivity a material being brass or aluminium,
a through hole with an inner surface being plain or threaded,
a length (L) of at least 5 mm, and
an outer diameter (A) of at least 10 mm.

10. An extension element according to claim 8, and comprising a core member and one or more cooling fins, wherein the one or more fins comprise an outer periphery, and wherein the outer periphery comprises any one or more of:
a shape being any one of circular, angular, rectangular, hexagonal, octangular and combinations of two or more thereof, and
a diameter (C) being at least 3 mm larger than an outer diameter (A) of the core member of the extension element.

11. An extension element according to claim 9, and comprising a core member and one or more cooling fins, wherein the one or more fins comprise an outer periphery, and wherein the outer periphery comprises any one or more of:
a shape being any one of circular, angular, rectangular, hexagonal, octangular and combinations of two or more thereof, and
a diameter (C) being at least 3 mm larger than an outer diameter (A) of the core member of the extension element.

12. A system according to claim 4, wherein the one or more cooling fins comprise an outer periphery with a diameter (C) being at least 3 mm larger than an outer diameter (A) of the core member of the extension element.
